(19) United States
(12) Patent Application Publication
(10) Pub. No.: US 2004/0166345 A1
(43) Pub. Date: Aug. 26, 2004

(54) Processes and articles useful for preventing cork taint in beverages

(76) Inventor: Charles A. Wicht, Longmont, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/375,826

(22) Filed: Feb. 26, 2003

(51) Int. Cl. B05D 3/02; B05D 7/22; B05D 1/18

(52) U.S. Cl. 428/484.1; 427/230; 427/421.1; 427/430.1; 220/592.01

(57) ABSTRACT

The present invention relates to methods of forming a film on articles potentially in contact with a beverage to prevent contamination of the beverage with chemical compounds responsible for “corked” taste. The present invention also relates to stoppers made using the processes of the invention, and stoppers comprising a core and a film that chemically bonds to compounds responsible for “corked” taste, including TCA and derivatives.

### BACKGROUND OF THE INVENTION

Field of the Invention

Traditionally, at least some bottle stoppers or closures in general and wine bottle stoppers in particular have been produced from a natural material known as cork, which is bark from the cork oak. Wine corks are produced from reproduction cork, which is bark that has re-grown after the original bark has been stripped off the tree. The production of cork begins with the stripping of the reproduction cork from the tree to produce cork slabs which are then stored for what may be a period of years.

Cork in many ways is an ideal material for bottle stoppers. Mechanical properties such as density, compressive strength and elasticity allow cork to provide an effective barrier to liquids while still providing for convenient removal from bottles via a corkscrew type device. Cork has been the traditional bottle stopper particularly for fine wines and holds a special mystique. Consumers associate natural corks with a higher-quality wine whereas consumers associate alternatives such as screw caps with lower quality wine.

Despite the advantages of cork for stoppers, cork has one particular disadvantage in that stoppers made of cork may subject liquids in contact with cork to contamination by compounds present in the cork which can lead to “corked” flavor, also called “cork taint.” Although cork has no intrinsic odor or taste, wood lignin itself and also fungi or other microbes on the cork or other sources of wood lignin, such as wooden barrels, can form off flavors and odors. Cork has ample opportunity for contamination with fungi or other microbes after harvesting, during storage, which may be as long as two years.

One major component of “corked” taste is 2,4,6-trichloroanisol (TCA) and derivatives. It is theorized that the mechanism of TCA formation is by the production of trichlorophenol followed by methylation of the phenolic moieties by fungi or other microbes. Chlorine is generally available in corks due to such sources such as free chlorine in water or from sodium hypochlorite used to sterilize corks. TCA contamination is a significant problem, with some estimates being that between 2% and 15% of world production of wine is affected by TCA. In worst case, it ruins the wine, and more frequently suppresses the flavors and aroma. Thus, it causes millions and perhaps billions of dollars of ruined or compromised wine that the industry believes damages relations with customers. Accordingly, there have been efforts in recent years to address the problem of cork taint in wines. The problem develops after shipping, it cannot be tested out completely, and efforts to test and cull are very expensive.

One solution to the problem of cork taint is to simply replace the cork stopper and use a synthetic stopper or screw cap instead. Synthetic stoppers are disclosed in U.S. Pat. No. 5,480,915; U.S. Pat. No. 5,496,862; U.S. Pat. No. 5,692,629; U.S. Pat. No. 5,710,184 and U.S. Pat. No. 5,855,287. However, completely synthetic corks have drawbacks. Synthetic corks use materials that are not as well accepted by consumers, who associate synthetic stoppers with lower quality wines. Additionally, because the properties of synthetic stoppers and cork stoppers differ, the same bottling line must be converted from operating with stoppers made of natural cork to stoppers made of synthetic material. Based on these considerations, it would be advantageous to modify natural cork such that it poses no danger of contamination of the wine stored within the bottle that is in contact with the cork.

Attempts to modify corks so that they do not cause cork taint has been another approach. U.S. Pat. No. 5,353,417 discloses a method of removing TCA from contaminated corks by steaming the corks. U.S. Pat. No. 6,152,966 discloses a process for removing TCA by treating cork with a phenol oxidizing enzyme such as lactase, peroxidase, catechol oxidase and o-amino phenol oxidase. However, these methods have in common that they are an additional step in treating corks before use in wine bottles thus adding to cork processing costs. Additionally, these methods do not address the problem of TCA developing within corks occurring after performance of the patented treatment methods, caused by microorganisms carried into the bottle by the wine itself or residual in the cork.

Another method of removing TCA taint, disclosed in U.S. Patent Application 2002/0022075, uses synthetic aliphatic polymers in a batch method where wine or other beverage is treated with synthetic aliphatic polymers before bottling. This method has the disadvantage of not being able to prevent taint that occurs from contact with the cork after bottling.

Yet another method of treating corks, disclosed in U.S. Patent Application 2002/0014468, discloses a jacket or coating of plastic barrier material that is applied by direct insertion or injection molding. However, the jacket operates by forming a virtually perfect sealing action by the plastic jacket preventing the cork from coming into contact with the wine. Any imperfections in the jacket will allow TCA to enter the wine through simple diffusion. The inventors have disclosed no active absorption of TCA by the jacketing material. Additionally, the methods for applying the jackets or coating are specialized, requiring either purchase of corks that have been treated in this manner or purchase of specialized equipment capable of doing injection molding with attendant gases, etc.

Thus there remains a need in the art to provide methods of treating corks in order to prevent cork taint, that do not necessarily require a perfect sealing action preventing any contact of the cork with the wine, and can be applied using simple methods using equipment that most cork processors and some winemakers already possess. There also remains a need for corks with this treatment.

### SUMMARY OF THE INVENTION

The present invention relates to a process for prevention of taint causing compounds from entering beverages, comprising forming a film on an article, where the film comprises a material that chemically bonds to at least one taint-causing compound. The material is present in such quantity as to sufficiently prevent any taint causing compounds from being detectable by taste or smell. At least a portion of the treated article is in contact with the beverage. More specifically, the beverage to be treated includes wine, brandy, beer whiskey, vinegar, and olive oil. The film material comprises a synthetic aliphatic polymer, for example, a polyolefin. In one embodiment, the process of forming a film on the article may be accomplished by dipping, spraying, painting and or hopper coating. In another embodiment, an additional layer may be formed over or under the film material on the treated article. This layer may be made up of paraffin wax, beeswax, and silicone, or admixtures thereof. This other material may be formed as a mixture or composite as well and combined with the material that chemically bonds with the taint-causing compound rather than being applied in layers.

The present invention also relates to stoppers made by the processes of the invention, and to stoppers comprising a core having properties of natural cork, a film that chemically bonds to at least one taint causing compound. The film is formed by a process that includes one or more of the following: dipping, spraying, painting and hopper tumbling.

### BRIEF DESCRIPTION OF THE FIGURES

FIG. 1 is a flow chart showing a process of the present invention where an article is treated to form a film capable of binding taint compounds followed by a treatment to form a frictional layer over the film.

FIG. 2 is a drawing of a stopper of the present invention functionally interacting with a beverage container, in this case a glass bottle. The drawing shows the contact between the treated surfaces and the glass bottle.

FIG. 3 is a drawing of a treated stopper of the invention which includes a cork core on which is formed a film that is capable of binding to taint-causing compounds.

FIG. 4 is a drawing of a treated stopper of the invention which includes a cork core on which is formed a film that is capable of binding to taint-causing compounds, over which is a frictional layer.

### DETAILED DESCRIPTION OF THE INVENTION

The present invention provides a process for preventing taint-causing compounds from entering beverages comprising the formation of a film onto an article. The film comprises a material that chemically bonds to at least one of the taint causing compounds in sufficient quantity as to sufficiently prevent the taint-causing compounds in the treated beverage from being detectable by taste or smell, and wherein at least a portion of the treated article is exposed to the beverage. The term ‘prevent’ as used herein refers to affecting the level or concentration of a taint causing compounds such that the levels are substantially reduced and desirably reduced to levels that are undetectable by taste or smell.

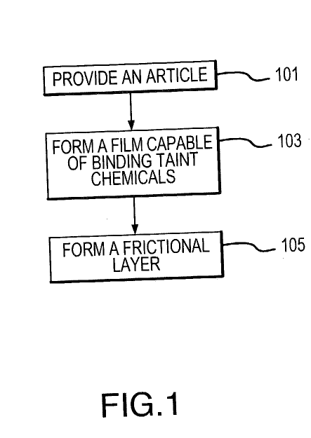

FIG. 1 is a flow chart which generally describes the steps in the process. In step (101), an article is provided. The articles of the invention include containers that hold beverages to be treated by the invention, such as for example a decanter, a glass bottle, a plastic bottle, and other containers known in the art for holding beverages including wooden barrels. A preferred article is a stopper. The term stopper includes metal screw caps and synthetic cork-like stoppers. A more preferred stopper is wood lignin, and the most preferred stopper is a natural cork stopper.

At step (103), the present invention utilizes a film that chemically bonds to at least one of said taint causing compounds. Preferred materials include synthetic aliphatic polymers. Suitable synthetic aliphatic polymers include polyethylene, low density polyethylene, high density polyethylene, polypropylene, high density polypropylene, and ultrahigh molecular weight polyethylene. The preferred polymer is low density polyethylene. In one embodiment, the low density polyethylene is chemically modified to have acid and hydroxyl groups.

Step (103) includes the process whereby the film is deposited onto the article. This process may be accomplished by any known method in the deposition arts, which includes injection molding and blow molding. A more preferred process of deposition includes spraying, dipping and painting. Methods to accomplish these methods of deposition are known in the art and are commonly described. The most preferred method of deposition is hopper tumbling. Hopper tumbling is well known in the art and is a commonly used technique to apply paraffin wax onto corks. Hopper tumbling is typically accomplished by using a machine similar to a commercial dryer, where measured levels of emulsified film material are placed together with articles to be coated, typically cork stoppers, and tumbled until a substantially even application of film has been applied to all stoppers. Methods to accomplish forming a film by hopper tumbling can be determined, for example, by looking up the melt temperature of the film material, bringing the material to a temperature close to the melt temperature, and placing emulsified film material in together with corks and tumbled. For example, the film material is heated just until the material is melted. Film deposition will also occur at temperatures below melting or in conditions that allow physical deposition, and at higher temperatures using techniques such as evaporation sputtering and the like.

The present invention does not require any particular thickness of the film. However, while not being limited to any particular thickness, for example, the film will have a thickness of less than 50 mils, more preferably less than 20 mils, and most preferably a thickness of between 1 and 20 mils. Thicknesses under 1 mil are also used in the present invention.

Without being bound by theory, the inventors contemplate that a very thin film, which may result in gaps in the film where the beverage may come into contact with untreated article, will remain effective to prevent taint-causing compounds from entering beverages, due to the fact that the film is capable of binding to taint-causing compounds. Thus, the inventors believe that taint-causing compounds present in the cork, that diffuses away from the cork through any pinholes or larger gaps in the film will, by equilibrium principles, preferentially be driven towards the absorbent film by binding with the film rather than diffusing out into the beverage. Thus, some gappage is tolerated.

In a stopper embodiment, for example, the coverage of the film over the surfaces intended for treatment, which is sufficient to prevent taint causing compounds from contaminating the beverage is greater than about 75%, more preferably greater than about 75%, and most preferably greater than about 90%. In a preferred embodiment, coverage is greater than 95%. So long as the portions of the stopper that contact the contained beverage are substantially covered, the beneficial features of the present invention may be achieved.

In another embodiment, less than all of the surfaces of the article are covered with the film. Methods by which partial coverage may be obtained are known in the art, and include masking portions of the article during deposition of the film and spraying directed to only a portion of the article. In a preferred embodiment, the film is deposited in an area that will have proximity to a source of taint compounds.

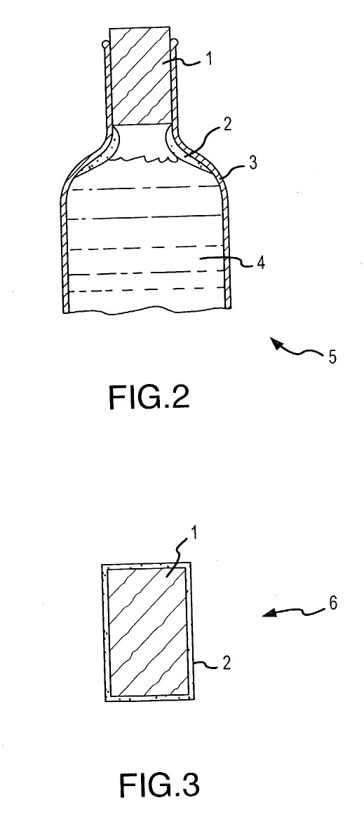

FIG. 2 depicts an embodiment where the article onto which the film is applied is a glass walled container 3, yielding a treated container 5. The film 2 only partially covers the interior of the glass walled bottle 3. The film 2 is formed on the lower portion of the neck and the upper portion of the body of the glass walled bottle 3, such that the film is in proximity to the untreated cork core 1. The beverage 4 contained within the bottle is therefore in contact with the film 2 both when the bottle is placed upright or when the bottle is lying prone (not depicted). If any other surface coatings are present on the container, film 2 must be the final layer, thereby enabling direct contact with the beverage.

In one embodiment, the film covers substantially the entire surface of the article. FIG. 3 depicts a preferred embodiment of a treated stopper 6 wherein the article to be covered is a cork stopper 1. The film 2 is formed over all surfaces of the cork stopper 1. However, film 2 may be formed on less than all surfaces (not shown.) One feature is that because film 2 is so thin, it does not materially affect the performance of the stopper or appearance.

FIG. 1, step (105) describes an optional embodiment of a frictional layer placed over the formed film on an article. Step (105) is a preferred step where the article to be treated is a stopper. A friction-control layer may either increase or decrease the coefficient of friction between the treated stopper and the container, compared to a treated stopper without a frictional layer. One of skill in the art can determine when such a layer is necessary, using considerations to optimize stopper behaviors such as, for example, enabling stopper to withstand corkscrew pressure while user is removing the stopper so as not to fall into the container or to prevent stopper from rotating axially within the container as a result of use of a corkscrew. Preferred frictional materials are paraffin wax, beeswax, and silicone, and mixtures thereof. It is routine in the art to determine an appropriate mixture of these frictional materials for a particular application. A preferred frictional material is a mixture of paraffin and beeswax, with a 10-30% by weight of beeswax and 70-90% by weight paraffin. Another, particularly preferred, frictional material is a mixture of paraffin and silicone. Methods to apply this frictional layer are known in the art. Particularly preferred is the hopper tumbling process, described elsewhere in this document, wherein the frictional materials are melted and blended together at a temperature of about 200° F., followed by tumbling with the article to assure an even film formation.

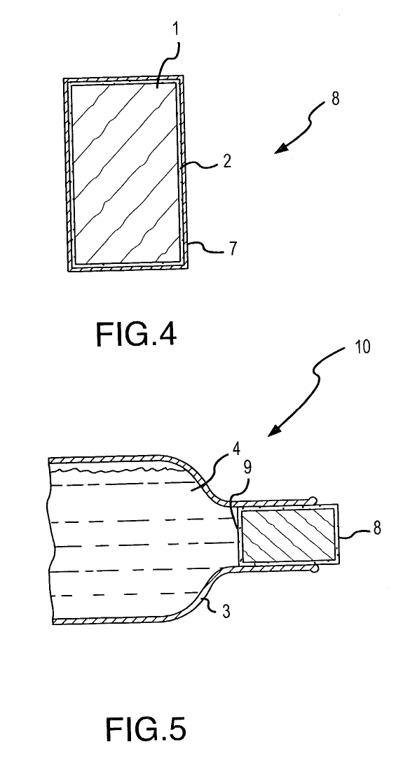

FIG. 4 depicts a treated stopper 8, which consists of a cork core 1, with a film 2 capable of bonding to taint causing compounds formed on all surfaces of the cork core 1. Over the film a frictional layer 7 has been formed. In another embodiment, a friction-control layer is formed under film 2 (not shown). In another embodiment, a frictional layer is formed as a composite or mixture with the film material (not shown).

FIG. 5 depicts a preferred use of a treated stopper 8. The treated stopper 8 is inserted into glass walled container 3, preventing beverage 4 from escaping the glass walled container 3 while lying prone. The treated stopper 8 is in contact with the beverage 4 along the bottom of the treated stopper 8, preventing taint causing compounds from entering beverage 4.

Beverages that can be treated by the present invention include any beverages that are stoppered by or have otherwise been in contact with wood lignin type materials, such as for example wooden barrel storage during aging. Typical beverages to be treated by this invention include, but are not limited to, wine, beer, vinegar, and whiskey. A preferred beverage to be treated is wine.

Taint-causing compounds can be defined as compounds that, when present in wine, contribute to “corked” taste, commonly defined as imparting off-aromas including mustiness, cardboard, earthy, and/or otherwise suppressing the inherent aromas and flavors of the wine. There are several compounds believed to be of importance in causing a “corked” taste. These include 2-methoxyphenol, pentachlorophenol, 2,3,4,6-tetrachlorophenol, several trichlorophenols, and cresol derivatives. Desirably, the film of the present invention prevents contamination with TCA. TCA is believed to arise by microbial transformation of naturally present phenols in wood lignins by microbia and/or fungi, and is the major contributor to cork off-flavor. The film of the present invention is selected to prevent these compounds from affecting the beverage.

In order for the present invention to reduce the presence of TCA to levels that are undetectable by taste or smell, the original concentration of releasable TCA in the cork is preferably below about 10 parts per trillion. However, in implementations where the coating is provided with a surface area significantly greater than the cork (e.g., when the bottle and/or bottle and cork are coated), higher levels of releasable TCA may be tolerable. TCA content that is present before bottling is also reduced in addition to eliminating compounds that are produced by the cork. The term ‘preventing’ taint causing compounds from entering beverages encompasses compound bonding of TCA already present in the beverage, as well as compound bonding of TCA as it diffuses out of a wood lignin containing article potentially in contact with a beverage. The term ‘prevent’ refers to affecting the level of TCA or other taint causing compounds to a reasonable level, such that the levels are substantially reduced and desirably reduced to levels that are undetectable by taste or smell.

The present invention also includes articles prepared by the processes of the invention.

The present invention also includes a stopper for containers, comprising a core comprising a substance having properties of natural cork. A substance having properties of natural cork includes synthetic stoppers as well as wood lignin stoppers. A preferred substance having properties of natural cork is cork lignin. This stopper also includes a film comprising a material that chemically bonds to at least one taint causing compound. This film is formed on at least one surface of the core. In a preferred embodiment, the film is formed by a method including spraying, dipping, painting and hopper tumbling. In the most preferred embodiment, the film is applied by hopper coating.

In a particular embodiment, the film has a thickness no greater than 20 mils. The stopper of the present invention alternatively includes a friction-control layer to modify the adhesiveness of the stopper.

We claim:

1. A process for preventing taint-causing compounds from entering beverages, comprising:
forming a film onto an article, said film comprising a material that chemically bonds to at least one of said taint-causing compound in sufficient quantity as to sufficiently prevent said taint-causing compounds in the treated beverage from being detectable by taste or smell, wherein at least a portion of said treated article is exposed to said beverage.

2. The process of claim 1, wherein said article comprises a natural cork stopper.

3. The process of claim 1, wherein said article comprises a container.

4. The process of claim 3, wherein said container is selected from the group consisting of a decanter, a glass bottle, and a plastic bottle.

5. The process of claim 1, wherein said process of forming a film comprises a method selected from the group of spraying, dipping, painting and hopper tumbling.

6. The process of claim 1, wherein said process of forming a film comprises hopper tumbling.

7. The process of claim 1, wherein said film covers less than all surfaces of said article.

8. The process of claim 1, wherein said film covers all surfaces of said article.

9. The process of claim 1, further comprising forming a frictional layer in proximity to said film on said treated article.

10. The process of claim 9, wherein said frictional layer is formed as a composite with said film.

11. The process of claim 9, wherein said frictional material is selected from the group consisting of paraffin wax, beeswax, silicone, and a mixture thereof.

12. The process of claim 9, wherein said layer is formed by a process selected from the group consisting of spraying, dipping, painting and hopper tumbling.

13. The process of claim 9, wherein said layer is formed by the process of hopper tumbling.

14. The process of claim 1, wherein said beverage is selected from the group consisting of whiskey, wine, olive oil, brandy, vinegar, and beer.

15. The process of claim 1, wherein said beverage comprises wine.

16. The process of claim 1, wherein said taint-causing compound comprises TCA.

17. The process of claim 1, wherein said film has a thickness of less than about 20 mils.

18. The process of claim 1, wherein said film has a thickness between about 1 mil and about 20 mils.

19. The process of claim 1, wherein said material comprises a polyolefin.

20. The process of claim 1, wherein said polyolefin is selected from the group consisting of polyethylene, low density polyethylene, high molecular weight polyethylene, polypropylene, and high-density polypropylene.

21. The process of claim 1, wherein said polyolefin is low density polyethylene.

22. An article prepared by the process of claim 1.

23. A stopper for containers, comprising:
a core comprising a substance having properties of natural cork;
a film comprising a material that chemically bonds to at least one taint-causing compound formed on at least one surface of said core.

24. The stopper of claim 23, wherein said film is formed by a method selected from the group of spraying, dipping, painting and hopper tumbling.

25. The stopper of claim 23, wherein said material comprises a polyolefin.

26. The stopper of claim 25, wherein said polyolefin is selected from the group consisting of polyethylene, low density polyethylene, high molecular weight polyethylene, polypropylene, and high-density polypropylene.

27. The stopper of claim 23, wherein said taint-causing compound comprises TCA.

28. The stopper of claim 23, wherein said film is formed on all surfaces of said core.

29. The stopper of claim 23, wherein said film has a thickness no greater than 20 mils.

30. The stopper of claim 23, wherein said stopper further comprises a frictional layer.

31. The stopper of claim 23, wherein said frictional layer is selected from the group consisting of paraffin wax, beeswax, silicone, and a mixture thereof.
